(19) United States
(12) Patent Application Publication
(10) Pub. No.: US 2019/0299384 A1
(43) Pub. Date: Oct. 3, 2019

(54) TOOL BIT TO BE USED WITH PNEUMATIC AIR HAMMER

(71) Applicant: David Matherson, Murphy, NC (US)

(72) Inventor: David Matherson, Murphy, NC (US)

(21) Appl. No.: 15/942,492

(22) Filed: Mar. 31, 2018

(51) Int. Cl. B25D 17/02; B25D 17/04

(52) U.S. Cl. CPC B25D 17/02; B25D 2250/111; B25D 2217/0007; B25D 17/046

(57) ABSTRACT

A tool bit to be installed on a pneumatic air hammer, the tool bit including a rod, a handle disposed on a predetermined portion of the rod, an insertion portion disposed at a first end of the rod to be fit into an attachment portion of the pneumatic air hammer, and a tip disposed at a second end of the rod.

### BACKGROUND OF THE INVENTION

### 1. Field of the Invention

The present general inventive concept relates generally to a tool bit, and specifically, to an improved tool bit to be used with a pneumatic air hammer.

### 2. Description of the Related Art

Cleaning industrial equipment often can improve the longevity of its functions, but pneumatic-powered bits can be hard to control while eradicating dirt and grime from moving parts and machinery. Moreover, removing components from heavy machinery before servicing can be a difficult and time consuming task, as they are prone to rusting and damages.

Therefore, there is a need for a tool that allows a user to effortlessly and efficiently clean heavy equipment without damaging its workings, components, or structure.

### SUMMARY

The present general inventive concept provides an improved air hammer pneumatic tool.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tool bit to be installed on a pneumatic air hammer, the tool bit including a rod, a handle disposed on a predetermined portion of the rod, an insertion portion disposed at a first end of the rod to be fit into an attachment portion of the pneumatic air hammer, and a tip disposed at a second end of the rod.

The rod may include a bent portion to be bent at a predetermined angle to offset a first portion of the rod disposed at a first end of the handle, with respect to a second portion of the rod disposed at a second end of the handle.

The tip may include a chisel tip having a sharpened edge.

The tip may be disposed on the second end of the rod with respect to a first plane or a second plane.

The tip may include a bent portion bent at a predetermined angle with respect to the rod.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a tool bit having a first configuration, according to an exemplary embodiment of the present general inventive concept;

FIG. 1B illustrates a tool bit having a first configuration, according to another exemplary embodiment of the present general inventive concept;

FIG. 1C illustrates a tool bit having a first configuration, according to another exemplary embodiment of the present general inventive concept;

FIG. 2A illustrates a tool bit having a second configuration, according to an exemplary embodiment of the present general inventive concept;

FIG. 2B illustrates a tool bit having a second configuration, according to another exemplary embodiment of the present general inventive concept;

FIG. 2C illustrates a tool bit having a second configuration, according to another exemplary embodiment of the present general inventive concept;

FIG. 3A illustrates a tip of a tool bit, according to an exemplary embodiment of the present general inventive concept;

FIG. 3B illustrates a tip of a tool bit, according to another exemplary embodiment of the present general inventive concept; and

FIG. 4 illustrates a conventional pneumatic air hammer.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

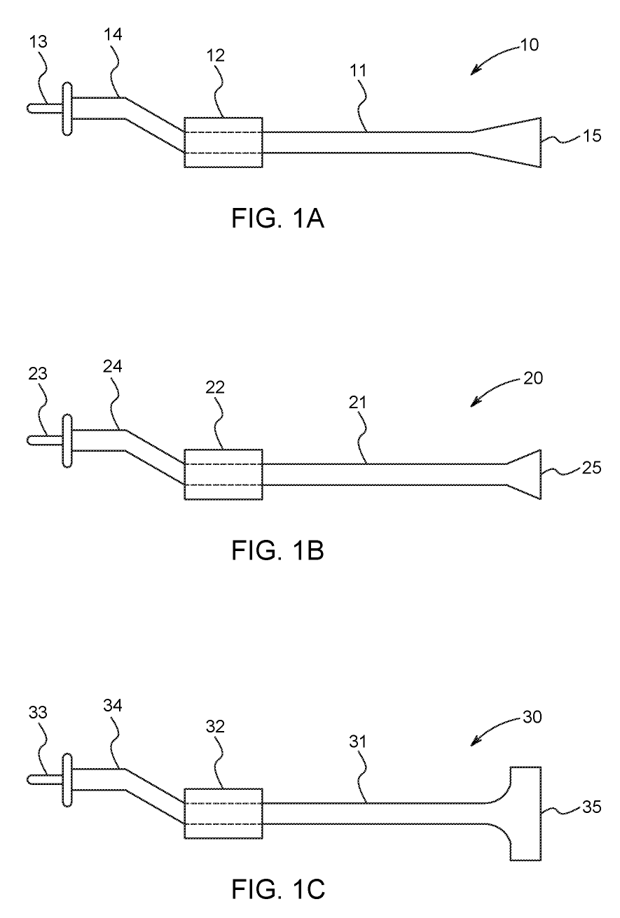

FIG. 1A illustrates a tool bit 10 having a first configuration, according to an exemplary embodiment of the present general inventive concept.

Referring to FIG. 1A, the tool bit 10 may include a rod 11, a handle 12, an insertion portion 13, a bent portion 14, and a tip 15.

The rod 11 may be made of metal, hard plastic, or any other type of durable material known to one of ordinary skill in the art.

The handle 12 may be made of rubber, plastic, or any other or any other type of durable material known to one of ordinary skill in the art.

The handle 12 may be disposed anywhere along the rod 11, in order to facilitate a user's grip on the tool bit 10.

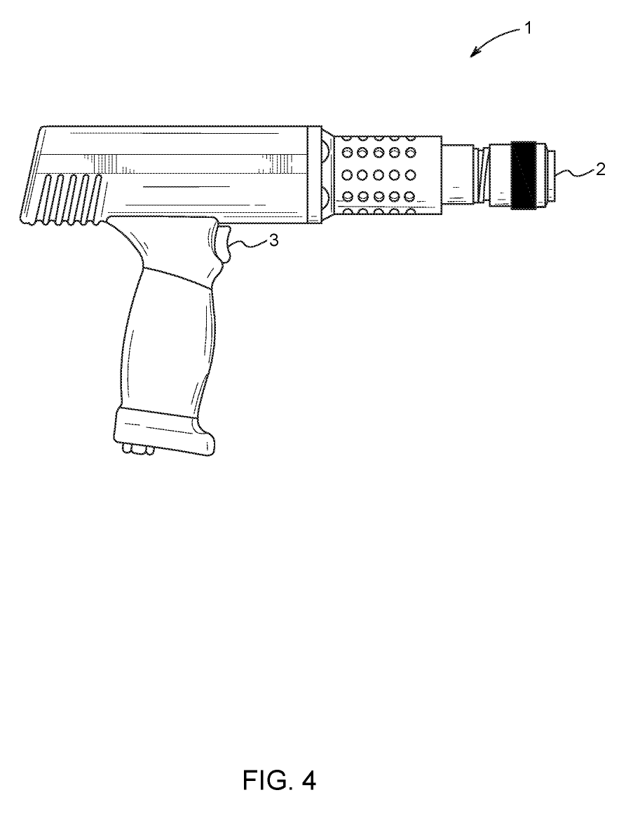

The insertion portion 13 may be disposed at a first end of the rod 11, and may be formed to fit into a conventional pneumatic air hammer 1, as illustrated in FIG. 4

The bent portion 14 may be bent at a predetermined angle to offset a first portion of the rod 11 disposed at a first end of the handle 12, with respect to a second portion of the rod 11 disposed at a second end of the handle 12.

The tip 15 may be disposed at a second end of the rod 11, and may have a predetermined shape, such as a large chisel, and may be sharpened at an edge portion thereof.

In the embodiment of FIG. 1A, the tip 15 is disposed on the rod with respect to a first plane.

FIG. 1B illustrates a tool bit 20 having a first configuration, according to another exemplary embodiment of the present general inventive concept.

Referring to FIG. 1B, the tool bit 20 may include a rod 21, a handle 22, an insertion portion 23, a bent portion 24, and a tip 25.

The rod 21 may be made of metal, hard plastic, or any other type of durable material known to one of ordinary skill in the art.

The handle 22 may be made of rubber, plastic, or any other or any other type of durable material known to one of ordinary skill in the art.

The handle 22 may be disposed anywhere along the rod 21, in order to facilitate a user's grip on the tool bit 20.

The insertion portion 23 may be disposed at a first end of the rod 21, and may be formed to fit into a conventional pneumatic air hammer 1, as illustrated in FIG. 4

The bent portion 24 may be bent at a predetermined angle to offset a first portion of the rod 21 disposed at a first end of the handle 22, with respect to a second portion of the rod 21 disposed at a second end of the handle 22.

The tip 25 may be disposed at a second end of the rod 21, and may have a predetermined shape, such as a small chisel, and may be sharpened at an edge portion thereof.

In the embodiment of FIG. 1B, the tip 25 is disposed on the rod with respect to a first plane.

FIG. 10 illustrates a tool bit 30 having a first configuration, according to another exemplary embodiment of the present general inventive concept.

Referring to FIG. 10, the tool bit 30 may include a rod 31, a handle 32, an insertion portion 33, a bent portion 34, and a tip 35.

The rod 31 may be made of metal, hard plastic, or any other type of durable material known to one of ordinary skill in the art.

The handle 32 may be made of rubber, plastic, or any other or any other type of durable material known to one of ordinary skill in the art.

The handle 32 may be disposed anywhere along the rod 31, in order to facilitate a user's grip on the tool bit 30.

The insertion portion 33 may be disposed at a first end of the rod 31, and may be formed to fit into a conventional pneumatic air hammer 1, as illustrated in FIG. 4

The bent portion 34 may be bent at a predetermined angle to offset a first portion of the rod 31 disposed at a first end of the handle 32, with respect to a second portion of the rod 31 disposed at a second end of the handle 32.

The tip 35 may be disposed at a second end of the rod 31, and may have a predetermined shape, such as a t-shaped chisel, and may be sharpened at an edge portion thereof.

In the embodiment of FIG. 10, the tip 35 is disposed on the rod with respect to a first plane.

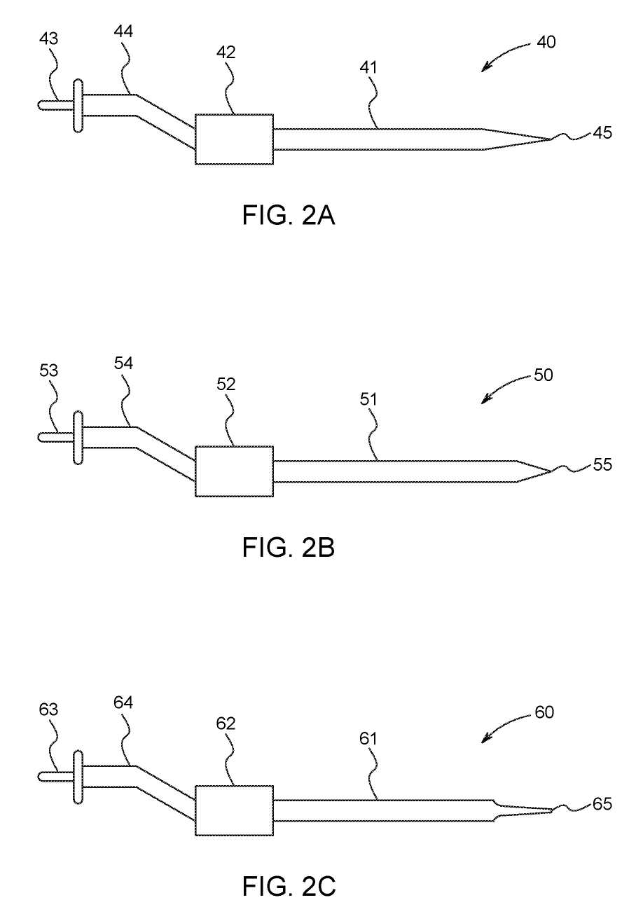

FIG. 2A illustrates a tool bit 40 having a second configuration, according to an exemplary embodiment of the present general inventive concept.

Referring to FIG. 2A, the tool bit 40 may include a rod 41, a handle 42, an insertion portion 43, a bent portion 44, and a tip 45.

The rod 41 may be made of metal, hard plastic, or any other type of durable material known to one of ordinary skill in the art.

The handle 42 may be made of rubber, plastic, or any other or any other type of durable material known to one of ordinary skill in the art.

The handle 42 may be disposed anywhere along the rod 41, in order to facilitate a user's grip on the tool bit 40.

The insertion portion 43 may be disposed at a first end of the rod 41, and may be formed to fit into a conventional pneumatic air hammer 1, as illustrated in FIG. 4

The bent portion 44 may be bent at a predetermined angle to offset a first portion of the rod 41 disposed at a first end of the handle 42, with respect to a second portion of the rod 41 disposed at a second end of the handle 42.

The tip 45 may be disposed at a second end of the rod 41, and may have a predetermined shape, such as a large chisel, and may be sharpened at an edge portion thereof.

In the embodiment of FIG. 2A, the tip 45 is disposed on the rod with respect to a second plane.

FIG. 2B illustrates a tool bit 50 having a second configuration, according to another exemplary embodiment of the present general inventive concept.

Referring to FIG. 2B, the tool bit 50 may include a rod 51, a handle 52, an insertion portion 53, a bent portion 54, and a tip 55.

The rod 51 may be made of metal, hard plastic, or any other type of durable material known to one of ordinary skill in the art.

The handle 52 may be made of rubber, plastic, or any other or any other type of durable material known to one of ordinary skill in the art.

The handle 52 may be disposed anywhere along the rod 51, in order to facilitate a user's grip on the tool bit 50.

The insertion portion 53 may be disposed at a first end of the rod 51, and may be formed to fit into a conventional pneumatic air hammer 1, as illustrated in FIG. 4

The bent portion 54 may be bent at a predetermined angle to offset a first portion of the rod 51 disposed at a first end of the handle 52, with respect to a second portion of the rod 51 disposed at a second end of the handle 52.

The tip 55 may be disposed at a second end of the rod 51, and may have a predetermined shape, such as a small chisel, and may be sharpened at an edge portion thereof.

In the embodiment of FIG. 2B, the tip 55 is disposed on the rod with respect to a second plane.

FIG. 2C illustrates a tool bit 60 having a second configuration, according to another exemplary embodiment of the present general inventive concept.

Referring to FIG. 2C, the tool bit 60 may include a rod 61, a handle 62, an insertion portion 63, a bent portion 64, and a tip 65.

The rod 61 may be made of metal, hard plastic, or any other type of durable material known to one of ordinary skill in the art.

The handle 62 may be made of rubber, plastic, or any other or any other type of durable material known to one of ordinary skill in the art.

The handle 62 may be disposed anywhere along the rod 61, in order to facilitate a user's grip on the tool bit 60.

The insertion portion 63 may be disposed at a first end of the rod 61, and may be formed to fit into a conventional pneumatic air hammer 1, as illustrated in FIG. 4

The bent portion 64 may be bent at a predetermined angle to offset a first portion of the rod 61 disposed at a first end of the handle 62, with respect to a second portion of the rod 61 disposed at a second end of the handle 62.

The tip 65 may be disposed at a second end of the rod 61, and may have a predetermined shape, such as a t-shaped chisel, and may be sharpened at an edge portion thereof.

In the embodiment of FIG. 2C, the tip 65 is disposed on the rod with respect to a second plane.

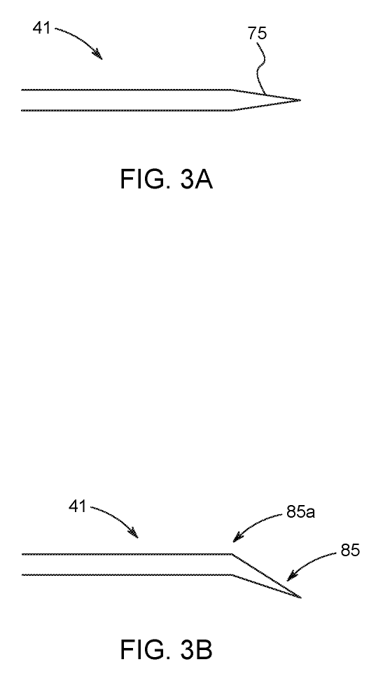

FIG. 3A illustrates a tip 75 of a tool bit, according to an exemplary embodiment of the present general inventive concept.

Referring to FIG. 3A, the tip 75 may be disposed to be straight and in line with respect to any one of the rods 11, 21, 31, 41, 51, and 61. FIG. 3A illustrates the tip 75 disposed on the rod 41, but may be provided on any of the rods 11, 21, 31, 41, 51, and 61.

FIG. 3B illustrates a tip 85 of a tool bit, according to another exemplary embodiment of the present general inventive concept.

Referring to FIG. 3B, the tip 85 may be provided with a bent portion 85a such that it is bent at a predetermined angle with respect to any one of the rods 11, 21, 31, 41, 51, and 61. FIG. 3B illustrates the tip 85 disposed on the rod 41, but may be provided on any of the rods 11, 21, 31, 41, 51, and 61.

All of the embodiments of the tools bits described above may be retro-fit into any type of conventional air hammer.

FIG. 4 illustrates a conventional pneumatic air hammer 1.

The conventional air hammer may include an attachment portion 2 and a trigger 3, but is not limited thereto.

Referring to FIGS. 1A through 3B, any of the aforementioned insertion portions 13, 23, 33, 43, 53, or 63 of the respective tool bits 10, 20, 30, 40, 50, or 60 may be installed at the attachment portion 2 of the conventional pneumatic air hammer 1.

A user may depress the trigger 3 to cause the conventional pneumatic air hammer 1 to reciprocate. When the conventional pneumatic air hammer 1 reciprocates while any of the aforementioned tool bits of FIGS. 1A through 3B are installed at the attachment portion 2, the user may use the tips of the tool bits to effortlessly clean heavy equipment without damaging its workings, components, or structure.

In other embodiments of the present general inventive concept, none of the bent portions 14, 24, 34, 44, 54, or 64 are required. As such, the rods 11, 21, 31, 41, 51, and 61 may be straight from end to end.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tool bit to be installed on a pneumatic air hammer, the tool bit comprising:
a rod;
a handle disposed on a predetermined portion of the rod;
an insertion portion disposed at a first end of the rod to be fit into an attachment portion of the pneumatic air hammer; and
a tip disposed at a second end of the rod.

2. The tool bit of claim 1, wherein the rod comprises:
a bent portion to be bent at a predetermined angle to offset a first portion of the rod disposed at a first end of the handle, with respect to a second portion of the rod disposed at a second end of the handle.

3. The tool bit of claim 1, wherein the tip comprises:
a chisel tip having a sharpened edge.

4. The tool bit of claim 1, wherein the tip may be disposed on the second end of the rod with respect to a first plane or a second plane.

5. The tool bit of claim 1, wherein the tip comprises a bent portion bent at a predetermined angle with respect to the rod.
